(19) United States
(12) Patent Application Publication
(10) Pub. No.: US 2005/0108030 A1
(43) Pub. Date: May 19, 2005

(54) System and method for planning and tracking certification plans

(75) Inventor: Hae Young Kim, Marina Del Ray, CA (US)

Correspondence Address: VENABLE, BAETJER, HOWARD AND CIVILETTI, LLP, P.O. BOX 34385, WASHINGTON, DC, 20043-9998, US

(73) Assignee: Sylvan Learning Systems, Inc., Baltimore, MD (US)

(21) Appl. No.: 10/715,137

(22) Filed: Nov. 18, 2003

(51) Int. Cl. G06F 17/60

(52) U.S. Cl. 705/1; 705/9

(57) ABSTRACT

A system and method for planning and tracking certification comprises generating one or more certification goals by a planner based on a user profile and an authority profile associated with a certification authority. The planner is responsive to user selection of one or more of the generated certification goals for creating a certification plan. A tracker that updates the certification plan in response to input regarding achievement of the one or more selected certification goals.

### FIELD OF THE INVENTION

The present invention relates generally to the field of user certification, and more particularly to meeting the requirements for such certification using a network of interconnected computers.

### BACKGROUND OF THE INVENTION

A number of professional occupations have associated certification requirements. Such requirements are usually specified by public or private institutions, such as national, state or local governments on the public side and various professional associations (e.g., medical, legal, or accounting, etc) on the private side. For example, state governments promulgate certification requirements for teachers, nurses, engineer and psychotherapists, among others. These professionals must meet an initial set of requirements to be licensed or certified to practice in their state, and must often meet continuing education requirements, such as additional course work, in order to stay certified.

Once a professional, such as a teacher, is required to satisfy a set of certification requirements in a state, it is up to the professional to determine what requirements have been met, what requirements are still needed to be met, and how to fulfill such requirements. For example, if additional course work is required, the teacher needs to identify what courses are offered by which institutions, and must keep track on her own of when those courses are completed.

Sylvan Learning Systems, Inc., the assignee of the present invention, provides a web site at ProfessionalTeacher.com that consolidates difficult-to-find information regarding teaching certification and re-certification requirements for all 50 states. The web site provides information on certification in each state and gives necessary forms, recommended reading and course work, and contact information for the departments of education of each state. The web site also provides information to certified teachers moving from one state to another state regarding certification requirements in that state.

There have been several approaches to training and certifying knowledge of students and professionals. For example, U.S. Pat. No. 5,590,057 to Fletcher et al. describes a system and method for training individuals in a specific task and then certifying that the individual knows how to perform the task. One of the draw backs of the disclosed system is that if the individual must be certified in more than one task, the system does not keep track of multiple requirements that need to be completed by the individual.

U.S. Pat. No. 5,788,504 to Rice et al. describes a computerized training management system that allows managers to develop a training materials database, correlated to reference manuals. U.S. Pat. No. 6,157,808 to Hollingsworth describes a computerized employee certification and training system and method for employees that require governmental certification or licensing. The training system associates employee qualifications, job descriptions, and training materials to determine if an employee is qualified for a job. Neither of the systems of the '504 patent and the '808 patent, however, track user certification requirements that an individual professional might need that are not training related, such as, for example, background checks or forms. Neither system tracks training that might occur outside of the employee's company.

U.S. Pat. No. 6,561,812 to Burmester et al. describes a system and method that correlate educational requirements with learning activities in schools, allowing a teacher to create lesson plans that meet the educational requirements. In this system, however, the system does not keep track of student completion of certification requirements.

Therefore, there exists a need for an automated system and method that consolidates certification requirement and further assists a professional in setting goals and tracking progress toward those certification goals.

### SUMMARY OF THE INVENTION

Briefly, according to one aspect of the present invention, a system and method for planning and tracking certification comprises generating one or more certification goals by a planner based on a user profile and an authority profile associated with a certification authority. The planner is responsive to user selection of one or more of the generated certification goals for creating a certification plan. A tracker that updates the certification plan in response to input regarding achievement of the one or more selected certification goals. According to some of the more detailed features of the invention, the tracker sends e-mail reminders to the user when a goal deadline approaches.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 is a block diagram of a web based system that incorporates various aspects of the user certification process of the present invention;

FIG. 2 an exemplary diagram depicting a user interfacing with the system of FIG. 1 for panning and tracking user certification according to the present invention;

FIG. 3 depicts an exemplary flow chart for accessing and using the user certification system of the present invention;

FIG. 4 is an exemplary System Access page;

FIG. 5 is the template of an exemplary User Home page;

FIG. 6 is an exemplary User Registration page;

FIG. 7 an exemplary New User Page;

FIG. 8 is an exemplary flowchart for creating a user ertification plan;

FIG. 9 is an exemplary User Information Entry page;

FIG. 10 is another exemplary User Information Entry page;

FIG. 11 is an exemplary Certification Requirement Summary page;

FIG. 12 is an exemplary Certification Credit Entry page;

FIG. 13 is an exemplary Certification Planner page;

FIG. 14 is an exemplary Certification Tracker Page;

FIG. 15 is an exemplary Certification Resource Registration page;

FIG. 16 is an exemplary an exemplary User Home page; and

FIG. 17 is an exemplary Grant Search page.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

The invention is directed to a computer-based online system. The professional seeking certification information and goal tracking assistance can access the data and services through any computer capable of connecting to a network. In one exemplary embodiment, the data and services are provided from one or more servers (or a central station) having access to one or more databases also connected to a network, and can be accessed through a standard web browser application, such as Microsoft Explorer or Netscape Navigator. The instant invention can also be implemented using Intranets systems for user certification in any governmental or non-governmental agencies as well as public or private institutions.

### The Exemplary Network

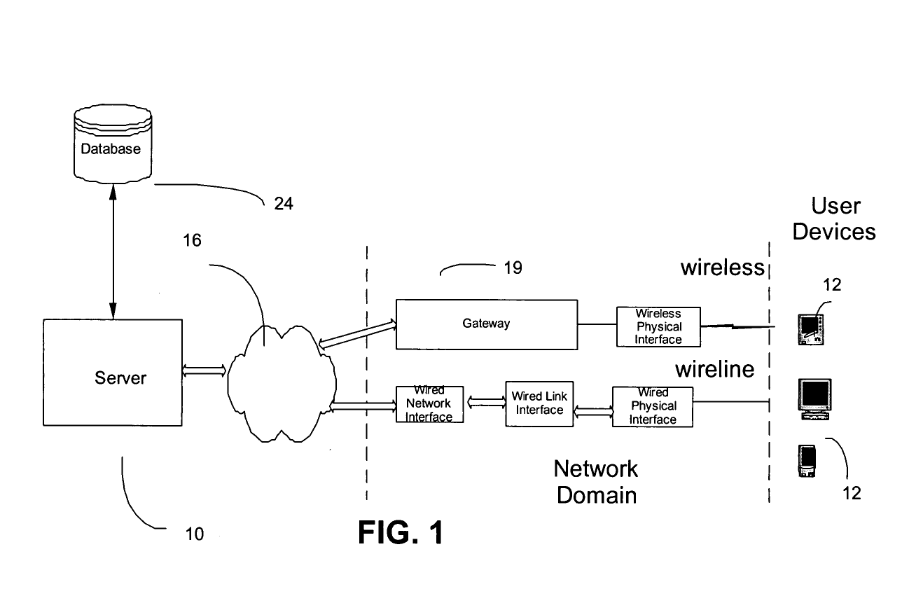

Referring to FIG. 1, an exemplary embodiment of a system that advantageously implements the various aspects of the present invention is shown. The exemplary system is implemented over a communication network that provides wired or wireless links to user devices (client devices) 12. The client devices 12 can be any computing device, such as a personal computer, etc. The present invention can use the standard Internet protocols for the various devices 12 that connect to one or more servers 10 with access to various types of databases 24. The Internet 16 is a collection of interconnected (public and/or private) networks that are linked together by a set of standard protocols to form a global, distributed network. It should be noted that although the exemplary embodiment described herein uses a client-server computing model, the present invention can also be implemented using any other suitable computing models, such as a central station or a computer mainframe connected to various types of terminals.

Under the present invention, client devices 12 can be any device that is used by anyone seeking user certification information and goal tracking, including a teacher, a nurse, an engineer, and a psychologist, etc. Examples of wired devices include personal computers, mobile computers, notebooks, workstations, etc., which operate under any workstation operating system, e.g., Windows or Mac OS operating systems. Examples of the wireless devices include personal digital assistant (PDAs) that operate under an appropriately configured operating system, such as Palm OS or Windows CE. The devices 12 include a visual display for providing a visual interface with a user. However, the devices 12 are also capable of communicating information in any form, including audio and video form, or in any other form conceivable by one skilled in the art.

The server 10 communicates with the devices 12 through the Internet 16 and through network layer interfaces 19. It is to be noted that the network used in connection with the present invention can use any one of open- or proprietary-network standards, such as TCP/IP protocols. Any type of suitable wired or wireless adapters can be used to connect a computer network to a user device 12. Examples of such adapters include, Ethernet, Wi-Fi, Bluetooth, etc.

As shown in FIG. 1, the system of the invention includes one or more databases 24 that can be managed centrally or in a distributed manner. The databases, which are accessible by the servers 10, store various information related to user certification and/or licensing requirements and individual goal data for each user in accordance with the present invention. Database 24 may contain user certification requirements for every state, and/or professional licensing requirements for every state depending upon the type of professional requirements to be monitored. For example, database 24 may contain certification requirement data in order to obtain at least one of a teaching certification/re-certification, nursing certification, certification/licensing for engineers, psychotherapists, accountants or other professionals. The user certification requirement data includes at least one of certification requirements, re-certification requirements, requirements for transferring certification from one state (province or other government entity) to another state (province or other government entity), certification forms and contact information for a government entity certification department. As stated above, the user devices 12 may include a personal computer, handheld communication devices, or any other devices capable of communicating with the database through the network.

As is known, the Internet 16 is a distributed network that supports the World Wide Web (“Web”). The Web refers generally to both (i) a distributed collection of inter-linked, user-viewable hypertext documents (commonly referred to as Web documents or Web pages) that are accessible via the Internet, and (ii) the user and server software components which provide user access to such documents using standardized Internet protocols. Currently, the primary standard protocol for allowing applications to locate and acquire Web documents is HTTP, and the Web pages are encoded using HTML. WML is the markup language used for by wireless application protocols, such as that specified by WAP. WAP is an XML-defined markup language similar to the HTML standard used on the Internet today. The WAP standard also includes a scripting language similar to JavaScript, but is optimized for WAP clients.

The terms “Web” and “World Wide Web” encompass future markup languages and transport protocols which may be used in place of (or in addition to) HTML, WML, XML, WAP and HTTP. The present invention can also operate on internal networks (Intranets) and networks utilizing different communication protocols. The Intranet model is typically used internally by companies to allow access to company information.

A Web Site is a computer system that serves informational content over the network using the standard protocols of the World Wide Web. Typically, a Web site corresponds to a particular Internet domain name and includes the content associated with a particular organization. As used herein, the term is generally intended to encompass both (i) the hardware/software server components that serve the informational content over the network, and (ii) the “backend” hardware/software components, including any non-standard or specialized components, that interact with the server components to perform services for Web site users.

The present invention supports an interactive web site. The site provides user certification requirement data for each state. It is through the interactive web site that the present invention can be implemented to provide a suitable teacher/user certification for any governmental or non-governmental agency or public or private institution. When a professional user logs into the site, he/she can create a personalized certification goal plan based on information provided by the interactive web site according to the invention. The goal plan is related to the certification requirements for a particular state. The professional user can then track the completion of certification requirements using the interactive software according to the invention. The site also provides online courses and distance learning classes that meet course work requirements for certification. Although the preferred embodiment of the present invention is implemented over a web-based configuration, it would be appreciated that the present invention can also be implemented under a configuration that does not require accessing a web-site. Rather, the interaction between the professional seeking certification and the computer network may through any suitable non-web based interface.

Overview of Certification Planning System

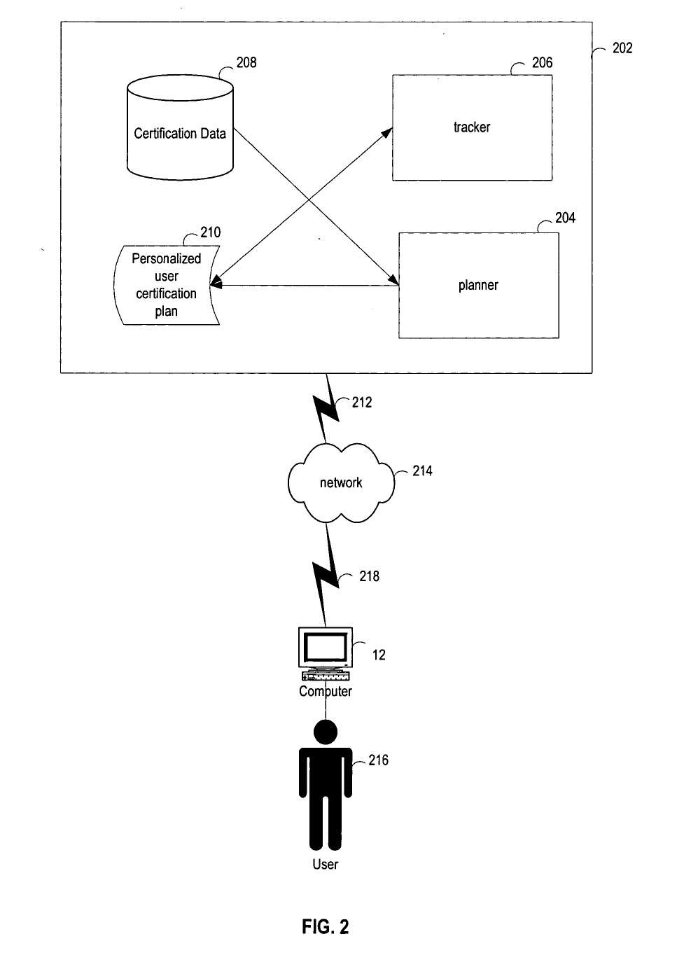

FIG. 2 is a block diagram that illustrates an overview of an exemplary embodiment of the system of the present invention. The certification goal planning system 202 can be implemented on one or more servers 10 or a central station. The system 202 has a planning module 204 and a tracking module 206. Data about user certification requirements can be stored in one or more databases 208. In addition, for every registered user, the system 202 creates and stores a personalized user certification plan 210. The system 202 has an interface 212 to a network 214, such as, for example, over the Internet or any other suitable network. A user 216 can access the system 202 through a computer 12, which has its own interface 218 with the network 214. In an exemplary embodiment, the user 216 uses a browser application on the computer 12 to interact with the system 202. User certification as herein defined means confirmation or attestation by a certification authority that a person meets governing standards or requirements in a user's field of endeavor. Examples of user certification include but are not limited to certification, re-certification, licensing, re-licensing in such fields of endeavor as education, medical, engineering, legal, accounting, sports, etc. Examples of certification authority include federal, state, county, local, municipal governments, public or private officials as well as governmental or non-governmental agencies or institutions, among others.

Accessing Certification Planning System

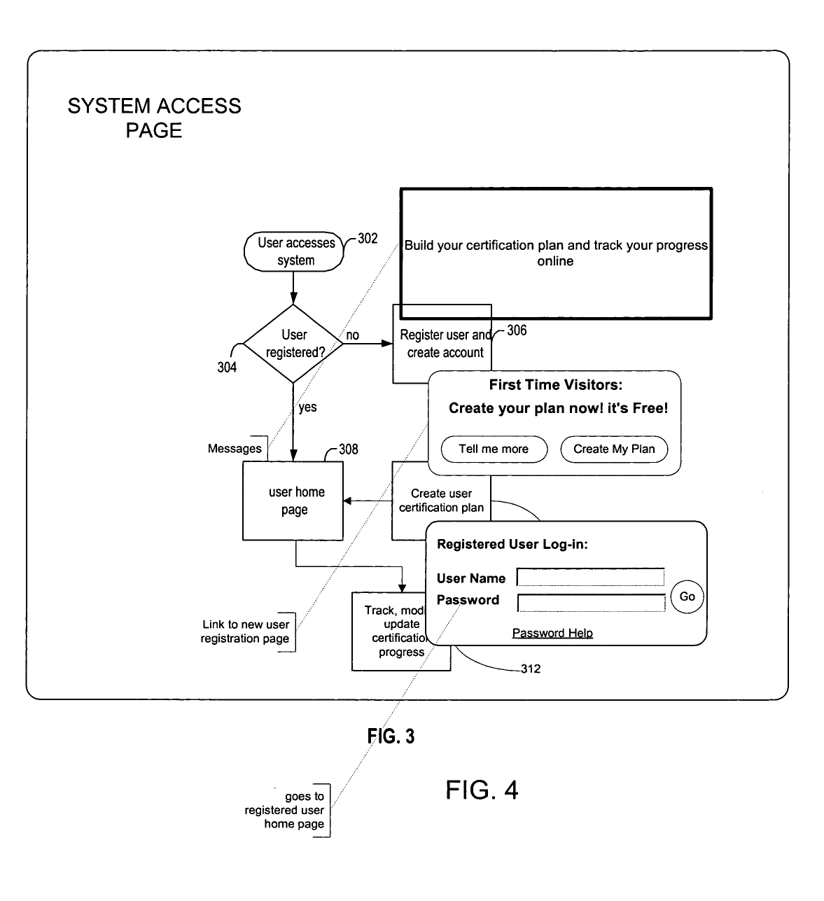

FIG. 3 is a flowchart that illustrates an exemplary embodiment for accessing and using the system of the present invention. When a user, such as a professional (e.g., teacher, nurse, engineer, accountant, etc.) accesses the system of the invention in step 302, a Systems Access page such as shown in FIG. 4 may be displayed. The System Access page allows a user to access the system of the invention through a web site provided by a server that is configured to mange certification plans. It should be noted, however, that the access to the system of the invention may also be through a suitable non-web based system access means.

The user can also access the system either directly, as explained above, or through another web site. For example, for teaching certification, links may be set up in various partner organizations, such as the National Education Association, so that teachers can access and create certification plans from that organization's web site.

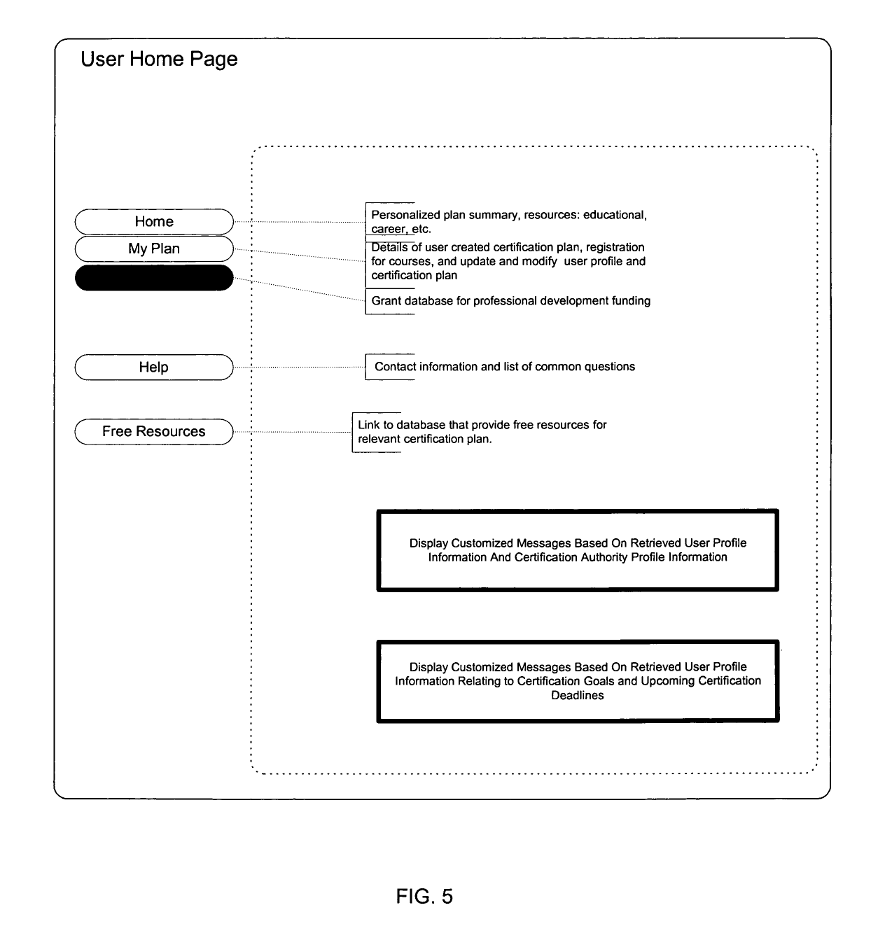

The System Access page includes a log-in section for registered users to log in. The System Access page also allows unregistered users to create a user account, which they may access by logging in to the system. Using this page, registered users can enter log-in information, e.g., user name and password, to access their account. Once a user's information is entered, a determination is made as to whether the user is registered or not, as shown in step 304 of FIG. 3. If a registered user logs in, the system displays the user's home page, as shown in step 308. FIG. 5 shows the template for a typical User Home page, which provides various links for managing user certification according to the present invention. The User Home page may be configured to display suitable customized messages based on retrieved user profile Information and a certification authority profile information. For example, if the user is a teacher wishing to certify or maintain state certification in, the displayed messages may be tailored based the related information solicited from the user and the state's certification requirements. Also, displayed may be messages regarding upcoming certification deadlines, or information of interest to the user.

If not registered, the user is prompted to register and create an account.

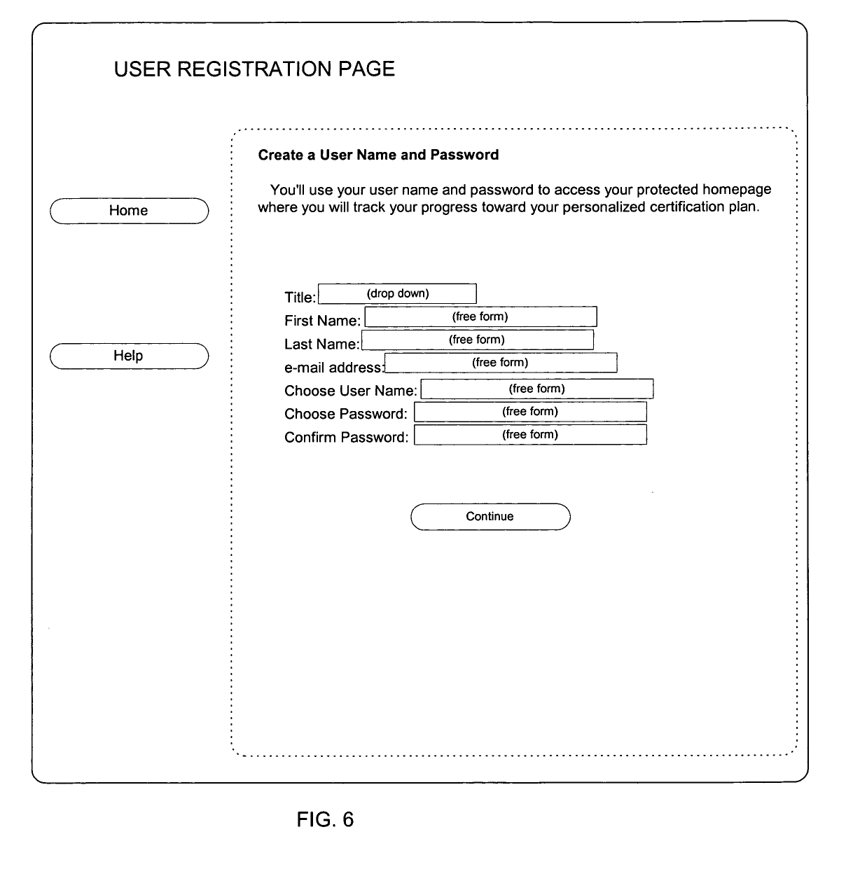

The user can create a unique user name and password during the registration process shown in step 306 of FIG. 3. FIG. 6 shows an exemplary User Registration page. The registration process, at a minimum, requires a user to enter his/her desired user name and password. The initial registration process may also require the user to enter additional information, such as name, address, phone number, e-mail address, credit card information, etc. After registration, the system creates a user account that the user can use to access his or her personalized home page. Using the created account, the user can create, plan and track progress toward certification goals in accordance with the present invention. All user-related information is suitably stored in a data base in corresponding records that store user profile information.

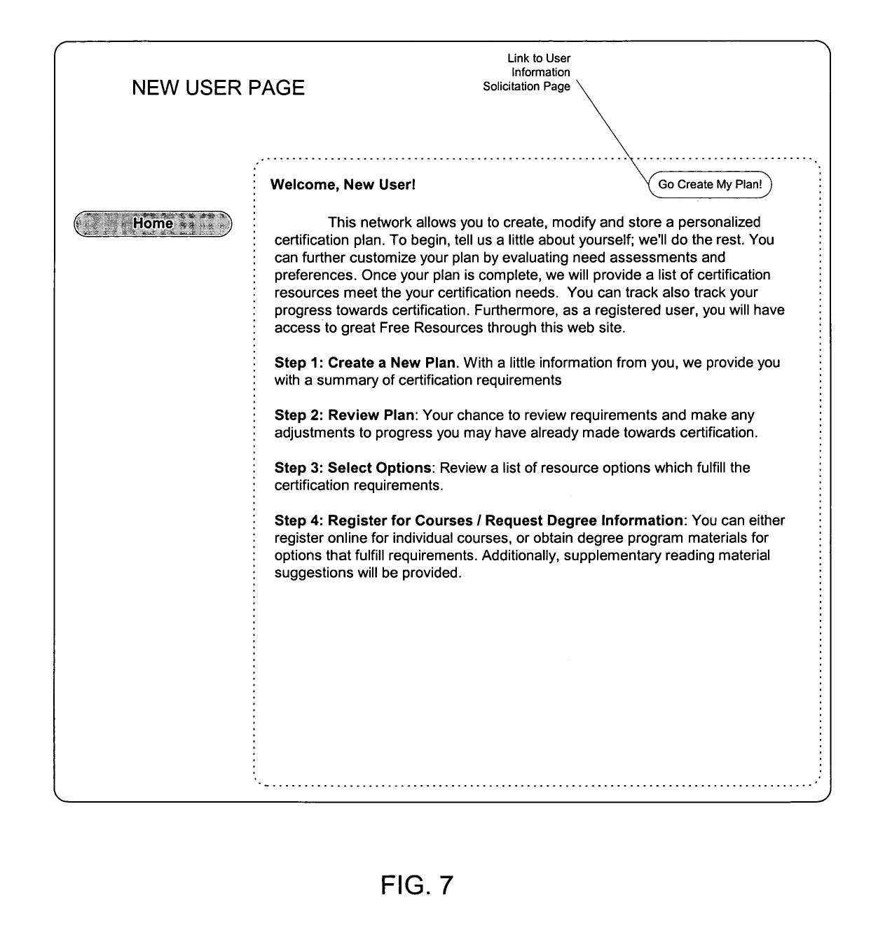

A newly registered user can use the system of the invention for creating a personalized user certification plan, as shown in step 310 of FIG. 3. The process directs the users to a New User page, which enables the user to create his/her personalized certification plan. FIG. 7 shows an exemplary New User page, which is the initial home page for a user without a certification plan. This page describes the steps necessary for planning and tracking certification goals, including the steps for creating the user certification plan, reviewing the requirements for certification, selecting certification goals, e.g., course and classes, that would fulfill the certification plan. A “Go Create My Plan” link on the New User page allows the user to create a certification plan.

Once the plan is created, the user can access the plan from the user's home page. Using the user's home page, the certification can be tracked, modified, updated, as shown in step 312. As described later, the home page also allows for registering for certification resources on-line.

Creating User Certification Plan

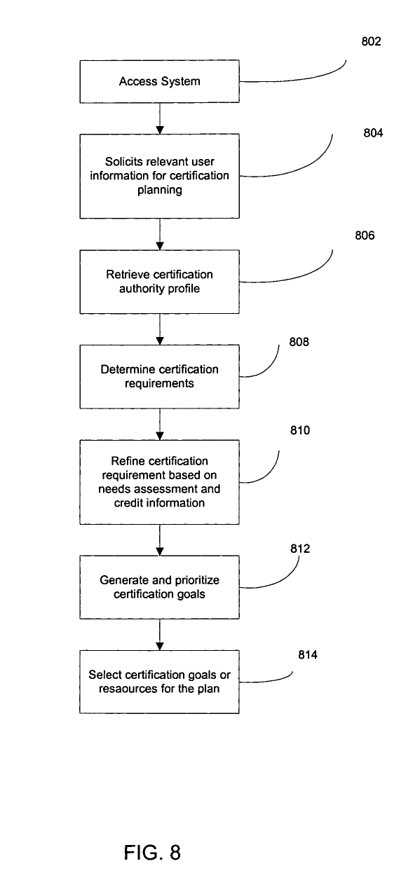

FIG. 8 shows an exemplary flowchart for creating a certification plan for a certification authority. In step 802, the system prompts the log in for system access system. In step 804, the system solicits a set of relevant user information for creating the certification plan. Exemplary solicited user information includes but is not limited to, the desired certification authority, e.g., one the states, number of years of experience in the field endeavor, academic information, e.g., degrees earned, specialties, and other details. For planning teacher certification in a state, for example, the system solicits information about years as a teacher, type of teacher certification, and the certification state of interest.

Based on the user information or profile, the system retrieves an information contained in a corresponding certification authority profile and determines certification requirements of the authority for certification, as shown in steps 806 and 808. Based on the certification requirements of the certification authority, the system of the invention generates certification goals.

A certification goal comprises performing one or more acts or events that measure skill in the field of endeavor. For example, a simple certification goal may require completing three hours of educational credit. The system also associates the certification goals with certification resources necessary to achieve the goals. For example, the three hours of educational credit may correspond to a course in a particular subject, reading a book, watching a video, listening to an audio program etc. The certification resources are then presented to the user, who may receive, order, or register for the resources online.

If necessary, the certification requirements may be refined or otherwise customized based on other parameters, such as Needs Assessment information or Certification Credit information. Needs Assessment information relates to strength, weakness or preferences of the user. Generally, such information can be obtained either objectively or subjectively, for example, by test, examination, observation, or evaluation. Based on Needs Assessment information, the certification requirements may be adjusted in determining certification goals, if required by the certification authority. For example, the user may be required to meet certain goals, if Needs Assessment information indicates weakness in the field of endeavor. Similarly, the certification requirement may be adjusted based on strength or preference in the field of endeavor.

Certification Credit information relates to a user's completed, in progress or planned activities that may refine certification requirements, if allowed by the certification authority. For example, certification goals may be reduced, because the user qualifies for credit for having completed or intending to complete a course or program in the field of endeavor. As such, the system of the present invention refines certification requirement based on Needs Assessment and/or Certification Credit information to determine goals of the certification plan, as shown in 810. The system of the invention can also prioritize the certification goals based on defined priority parameters, as described later in more detail, step 812.

Once certification goals are determined, the user is presented with a planner that allows the user to select certification goals that constitute the user's certification plan, step 814. The planner can also present the certification resources that are associated with the certification goals for selection. The selection may be made from a list of certification resources, such as classes, courses, books, testing resources, which fulfill the certification goals. The certification goals can also require filling out forms, reading books, participating in a lecture (video, audio, live, etc.), and other material; or additional course work to be completed, etc. In one exemplary embodiment, the user can select certification goals, for example, classes, courses, lectures, seminars, forms, etc., to be included in the certification plan by checking corresponding items from a list of certification resources presented to the user. The system receives the selection and then generates a personalized user certification plan. As such, the certification plan can comprise either certification goals and/or certification resources.

Certification Authority Profile

The system of the invention stores certification requirements for each certification authority in suitable databases. Such certification requirements may be stored in a variety of ways, for example, as records having fields for storing information relating to certification requirements of a corresponding certification authority. As such, the system of the invention profiles each certification authority based on its specific certification requirements.

User Information Profile

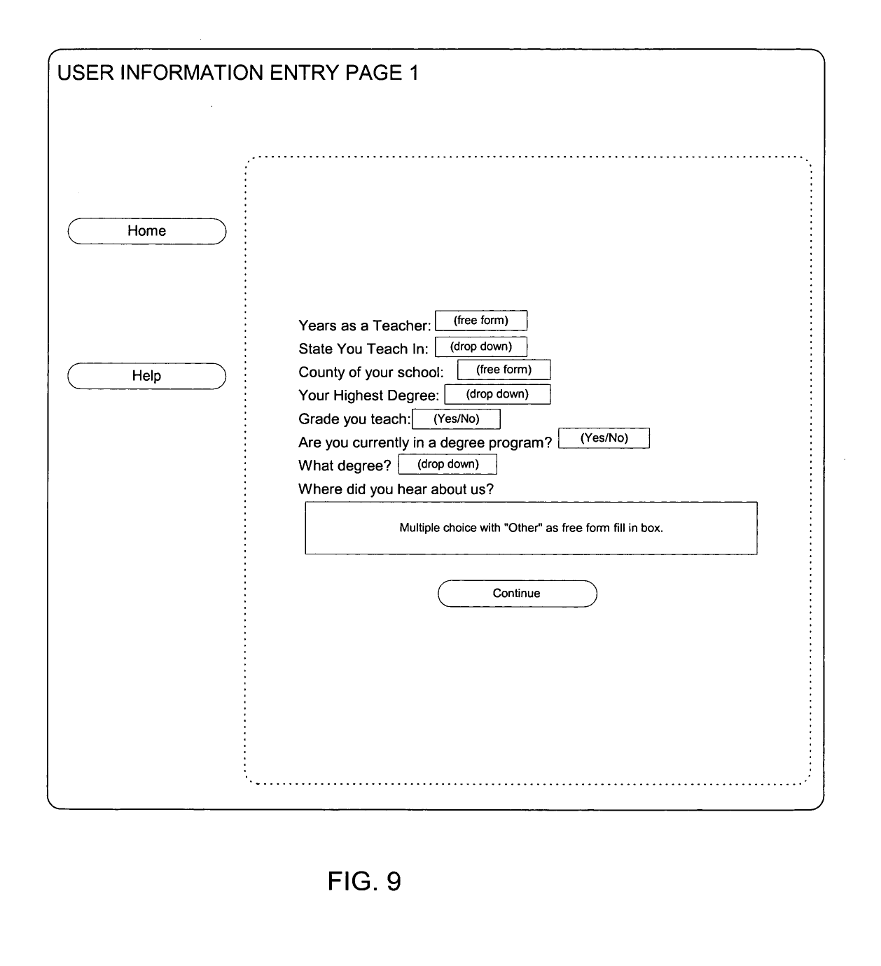

FIG. 9 shows an initial page presented to the user for creating an exemplary teacher certification plan at a state within the US. However, the screen can be tailored for creating any other type of user certification plan. Essentially, the initial screen solicits relevant user information for creating the user certification plan. The information solicitation and the entry of user information can be accomplished in a variety of ways. For example, any suitable interface, such as graphics, text, audio, etc. can be used.

In the exemplary embodiment shown in FIG. 9, the solicited information are textual questions presented on the page, and the user enters responses to the solicited information in defined fields. As shown in FIG. 9, the input into the fields may be in free form, i.e., user text entry, or contain predefined responses presented by drop down fields, or one or more binary entries, e.g., YES/NO, or otherwise multiple choice entries, where the user can select an appropriate entry, among others. For creating the exemplary teacher certification, the solicited information fields include, “Years as a Teacher,” “State You Teach In,” “County of your school,” “Your Highest Degree,” Grade You Teach,” etc.

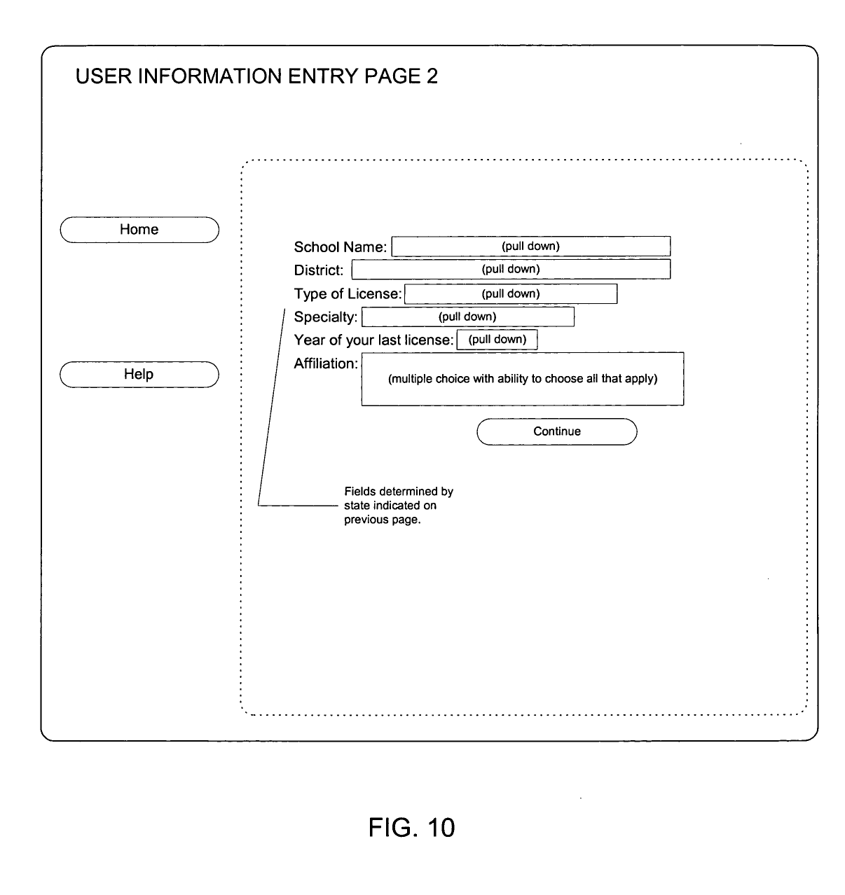

However, additional user information may be needed that can only be solicited based on previously entered user information. For example, user information entered in “State You Teach In” field may be needed in order to solicit information regarding the type of state licenses for which the certification plan is being created. Under such situations, a subsequent “Create Plan” page can be presented to the user having input fields presented based previously solicited user on a previous page. One such subsequent page is shown in FIG. 10, where the pull down field for “Type of License” is presented based on user information entered in the “State You Teach In” field entered on previous page shown in FIG. 9. Additional subsequent pages can be presented to the user until all the necessary user information for creating a certification plan is gathered. The gathered user information is suitably stored in the database along with other user information in the record that contains the users profile.

Generating Certification Goals

A planner according to the present invention uses user and certification authority profile information to determine the certification requirements for the field of endeavor. Based on such requirements, the planner generates certification goals that the user should achieve to get certified. For example, teacher certification requirements for a selected state may be profiled in terms of years of experience, degree, or any other pertinent information. Based on the entered user information, the planner presents the certification requirement in terms of goals that the user should fulfill in order to become a certified teacher in the selected state. The certification goals may correspond to various measurable activities, including filing out forms, reading books, completing one or more course, completing a degree program or meeting an other defined and measurable criteria. In one embodiment, achievement of the certification goals may be measured in terms of hours, units, or credits for courses, classes, seminar, sessions, etc. In other embodiments, the goals may be achieved by taking and passing a required test or fulfilling the requirement of a degree program (e.g., a masters degree). The goals may also require the user to meet goal-completion deadlines and due dates as required by the certification authority.

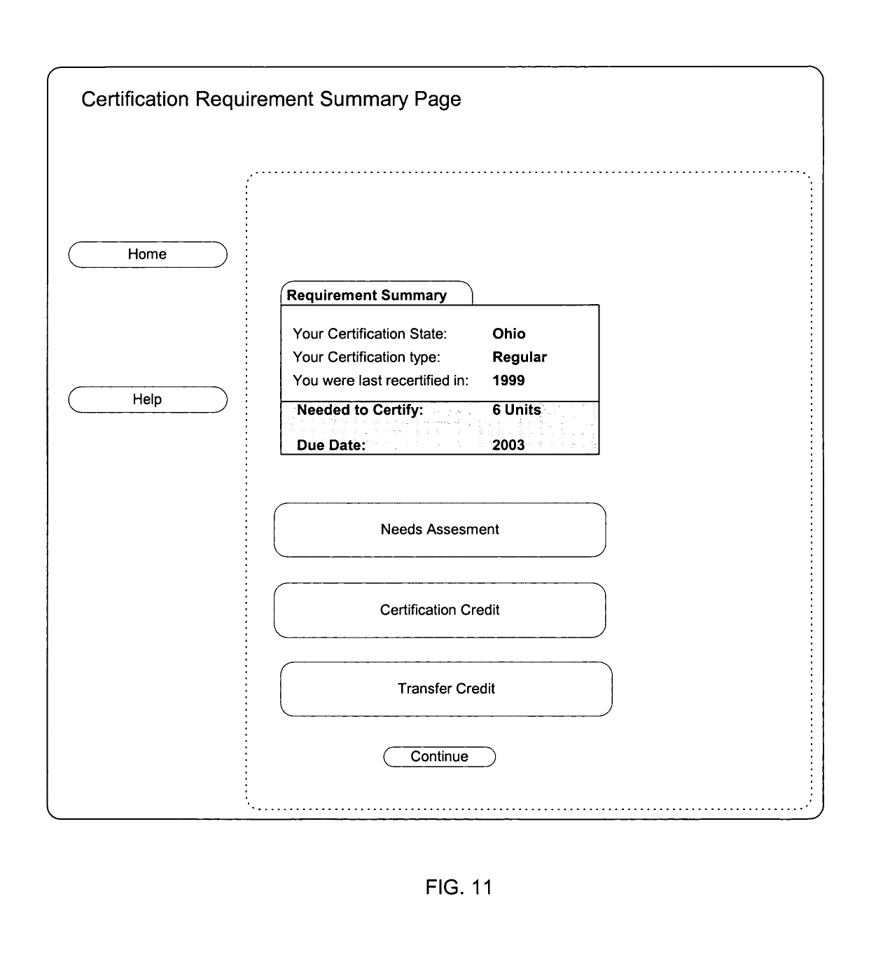

FIG. 11 shows a Certification Requirement Summary page. The certification requirements shown on this page are generated based on information in the use and certification authority profiles. This page allows the user to review the certification requirements. A “Requirement Summary” section shows the state of certification, the type of certification, the year the user was last certified and the number of “units” needed to re-certify, as well as the due date for rectification. While the certification goal measurement is in terms of “units,” other goal measures, such as hours or credits, may be used to track certification goals.

As stated above, one feature of the invention allows the planner to refine the certification plan based on needs and preferences of the user. If necessary, the Certification Requirement Summary page provides links that allows the system of the present invention to assess needs and preferences of the user, for example at another site. Such professional assessment information can pinpoint a user's areas of weakness, strength or interest. Based on such assessment information, the planner may customize the goals for user certification. As such, the user may use a “Needs Assessment” link to access his or her needs in the field of endeavor, for example, by taking tests designed to assess such needs.

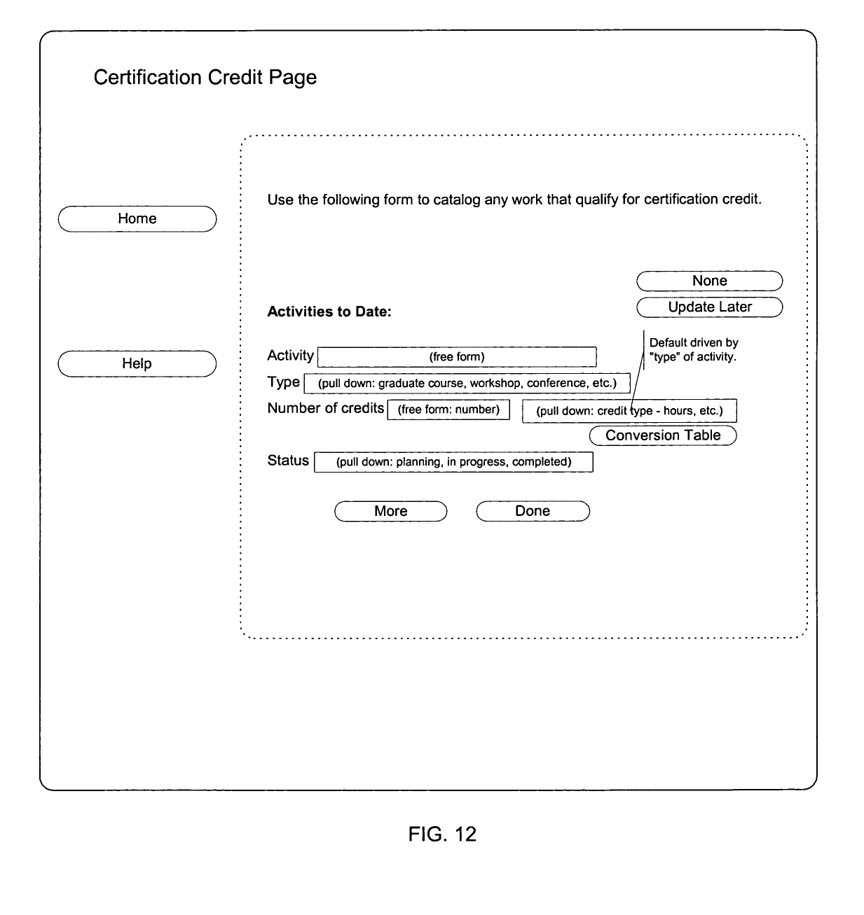

Another feature of the present invention allows the planner to take into account certification credit, for example, for previously taken courses, etc. FIG. 12 is a “Certification Credit” link that allows the system to take into account all such user activities. This page solicits user information regarding completed, in-progress and planned activities and their type (e.g., graduate course, workshop, conference, etc.) that may qualify for certification credit. The planner can also require the user to enter a credit measurement for such activity, e.g., the number of hours, unit, or credits earned for the professional activity. Since some programs are measured in different “units”, the page requesting information on the professional activity credit may include a conversion table where the user can convert one set of measurement to another. If the professional activity has not yet been done, the user can indicate that the activity is in-progress or being planned.

In another embodiment, the system enables the user to transfer certification credit from one certification authority to another. A “Transfer Credit” link allows the uses to transfer credit earned from another certification authority to be applied to certification requirements on the other certification authority. For example, under this arrangement teachers can transfer credits earned in one state to another.

Once the planner receives a user's Needs Assessment, Certification Credit and/or Credit Transfer information, it adjusts the certification requirements accordingly to generate the certification goals to fulfill the certification requirements.

The planner can generate certification goals based on defined priority parameters. For example, certification requirements of an authority may take precedence over Needs Assessment and/or Certification Credit, when generating certification goals. Alternatively, temporary or ad hoc certification initiatives of the certification authority may have lower priority than more permanent and standard certification requirements, but higher priority than the Needs Assessment and/or Certification Credit. Under this embodiment of the invention, the planner generates certification goals based on defined priority parameters that relate to the certification requirements of of the certification authority.

Planning Certification

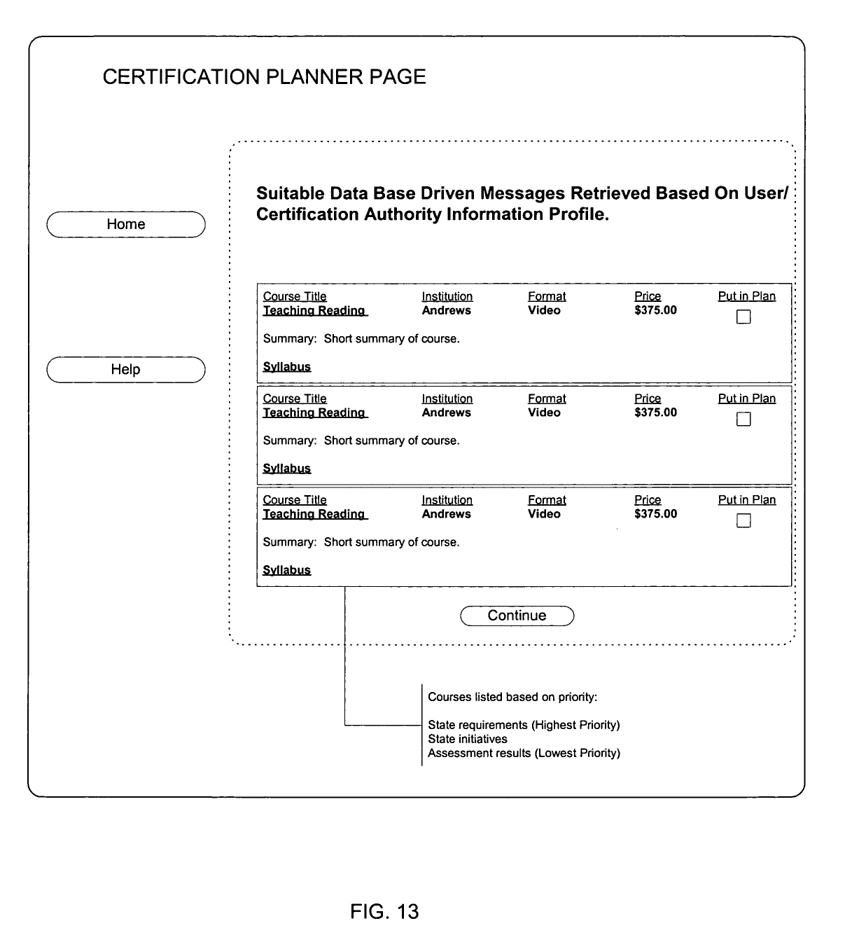

Planning comprises selecting certification goals. FIG. 13 shows an exemplary Certification Planner page that allows the user to select the goals for creating the certification plan. The planner also associates the certification goals with corresponding resources that facilitate achieving the goals.

In the exemplary Certification Planner page shown in FIG. 13, the user can choose required courses that have been associated with a generated certification goal based on the certification requirements of the authority. The user can select the required courses by marking a box, for example. As shown, the Certification Planner page presents various information and links associated with each course on the list, including course title, the institution presenting the course, course format (e.g., online, video, or other), course description/summary, etc. In addition, price information for taking the listed courses. It should be noted that completing courses is just one example of certification goals that may be presented to the user in the Certification Planner page. As stated before, other examples include but are not limited to requiring the user to take a test, perform an act, complete a degree, fill out a form, etc.

The Certification Planner page allows the user to create the certification plan by selecting one or more or all of the certification goals that are to be included in the certification plan. As shown, a “Put In Plan” box is associated with each listed course allowing the user to include one or more selected courses in the certification plan by marking the box. It should noted that the user may or may not be required to purchase a course in order for it to be included in the certification plan.

As explained above, the certification goal list may be generated based on priority filters. In the Certification Planner page illustrated in FIG. 13, for example, the courses are listed based on state requirements, state initiatives, and assessment information, with state requirements having the highest priority and assessment information having the lowest priority.

Tracking Certification Plan

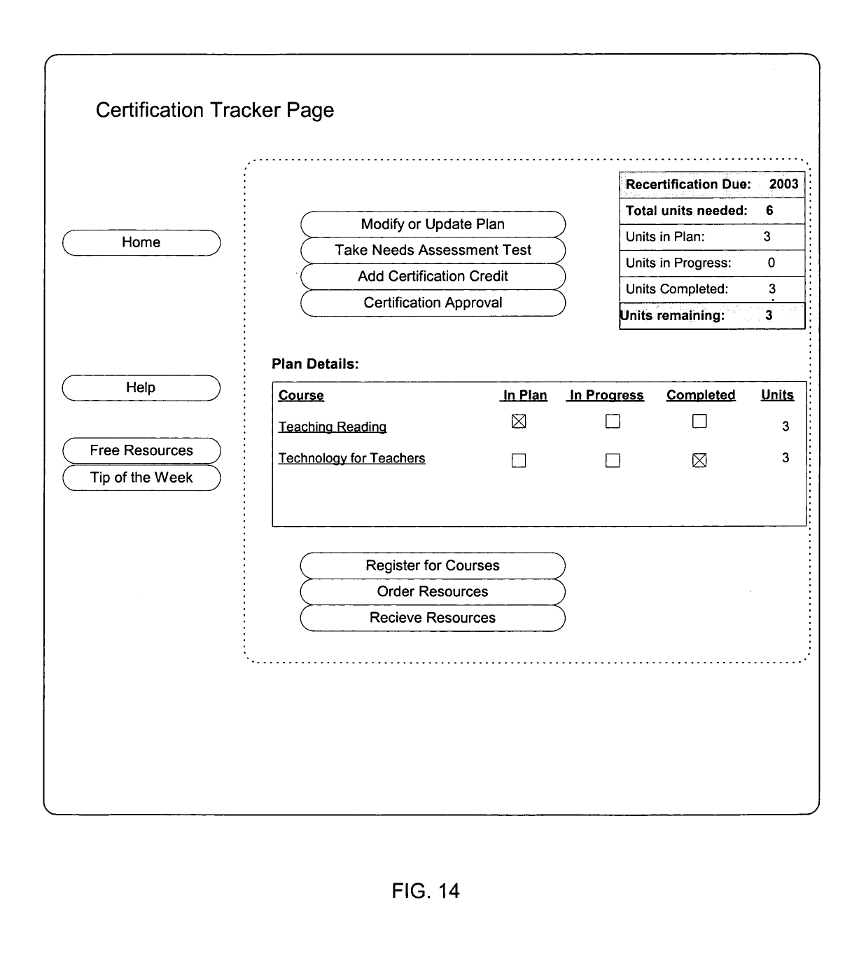

FIG. 14 illustrates an exemplary Certification tracker page that presents the selected certification goals that are included in the user's personalized certification goal plan in terms of courses that need to be taken for certification. The page includes a “Plan Detail” section that lists the selected courses during the certification goal selection and planning process described in connection with FIG. 13. Another section of the Certification Plan page indicates how many units are needed, certification due date, and the number of units that are in the plan, in progress and completed. In this way, the page provides tracking information for completed courses, and shows how may units are need to achieve certification.

Accordingly, the system of the invention includes a tracker that is responsive to input relating to the completion of one or more selectable certification goals for updating the user certification plan. Depending upon user's progress status, the tracker can change the status in order to update the plan. As shown in FIG. 14, some of the selected courses are initially marked as “In Plan.” The tracker can update the status by changing the status to “In Progress” or “Completed” as the user progresses with the certification plan.

The tracker can update the certification plan based on a user input or a non-user input. As such, the user may or may not be given control in updating the status of the certification plan. For example, if control is given to the user to update the certification plan, her or she can check the “Completed” box after having achieved a certification goal. As such, in one embodiment, the tracker updates the certification plan based on user input. In another embodiment, the tracker can update the certification plan automatically, based on status information received from a non-user, for example an entity that confirms the achievement of a certification goal by the user. For example, an educational institution can provide status information that confirms the user has completed a course required for achieving a certification goal. Either way, progress towards completing certification goals can be tracked based on input relating to completion or otherwise achievement of one or more of certification goals for updating the user certification plan.

In another embodiment, the tracker transmits e-mails to the user in connection with the certification plan or with respect to one or more certification goals. The e-mails could be information e-mails, reminder e-mails, or alert e-mail automatically generated by the tracker based on user information profile, which includes information regarding the user's certification plan.

Modifying and Updating Certification Plan

Using the Certification Tracker page, the user can also review, update or otherwise modify the certification plan, for example, by adding, deleting certification goals. The updating process using the “Update Plan” link can be configured to accommodate those that are updating the entire certification plan versus those that are updating work done to date. A “Take Needs Assessment” link allows the user to take steps assess needs in the field of endeavor. An “Add Certification Credit” link allows the user to enter certification credit. A “Certification Approval” link allows the user to a created certification plan to the certification authority for approval. Once approved, the system stores approval information in the user's profile.

Certification Resources

Certification resources are associated with certification goals.

Although not necessary, more than one certification resource of the same or different type may be associated with one or more certification goals. For example, a certification goal requiring 15 hours of educational credit, may be associated with 5 three-credit courses that may be taken in the same or different educational institution. Alternatively, such requirement may be fulfilled by a combination of courses, reading material, seminars, etc. The system of the present invention includes a certification resource generator that based on a certification goal input the provides associated certification resources.

Certification resources comprise courses, programs, sessions, seminars, audio or video lectures, books, tests, forms, etc. A course comprises one or more lectures relating to a subject in the field of endeavor. A program is a series of courses constituting a curriculum. A program can be degreed or non-degreed. The course or program may be live or self-paced taken on-line or off-line. Thus, various formats can be used in connection with the certification resources, including video, audio, live, on-line, off-line, self-paced, etc.

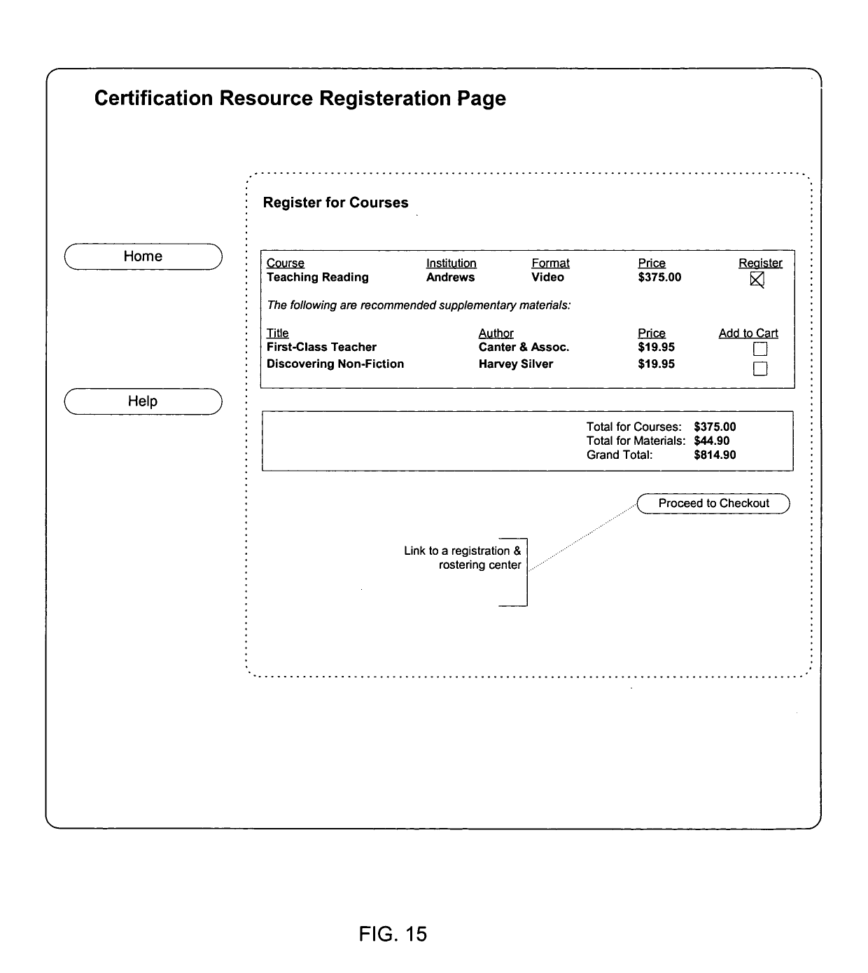

The system of the present invention also includes an on-line module that allows the user to order, receive or register for resources associated with certification goals as appropriate. A “Register for Course” link can register the user for selected course(s), seminar(s), sessions, degree programs online. Upon completion of registered courses or programs, a user can use the tracker to update the certification plan. FIG. 15 shows an exemplary Certification Resource Registration page the user can use to register for or receive any one of resources necessary for achieving certification goals. In other instances, the certification goals can be met by various distance-learning systems, a video course program, a computer-based learning program, or other media format, all of which can be ordered, on line using the present invention.

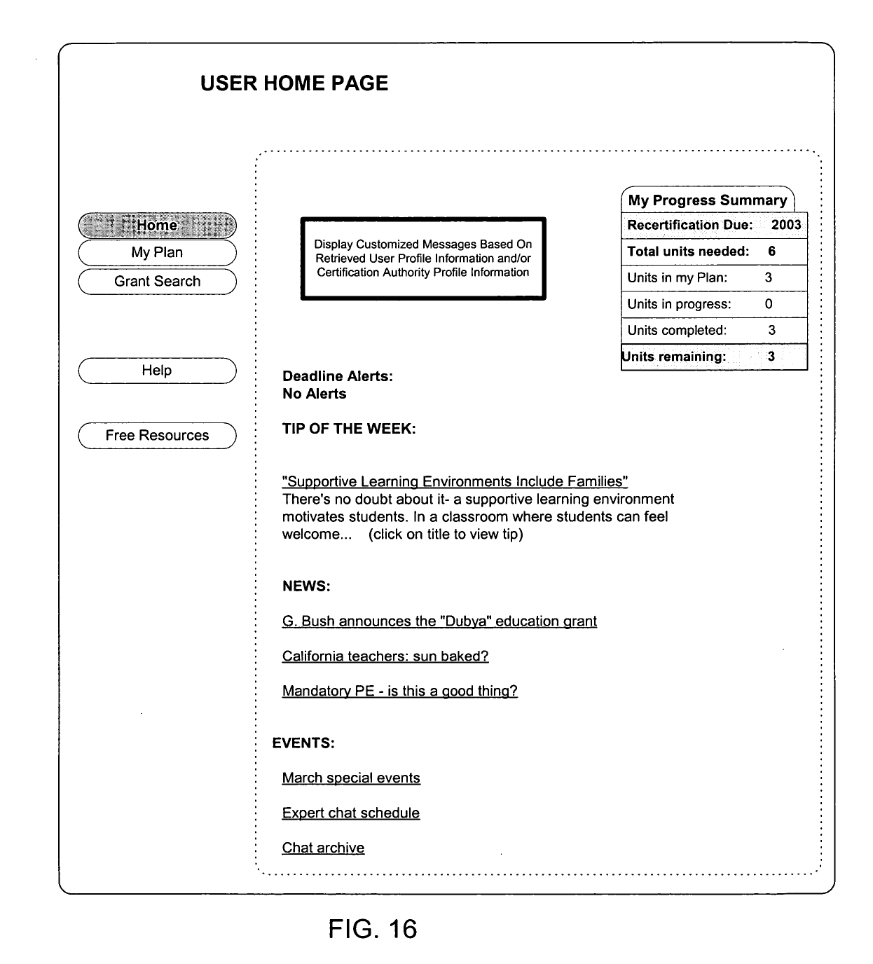

FIG. 16 shows an exemplary User Home page. This page provides various links to the user that allow for accessing various resources. The page include a “Plan Progress” section which presents user's progress summary of certification goals. A “My Plan” link allows the user to access the Certification Planner page described in connection with FIG. 14. Also, the user home page includes an alert section that provides certification alerts to the user.

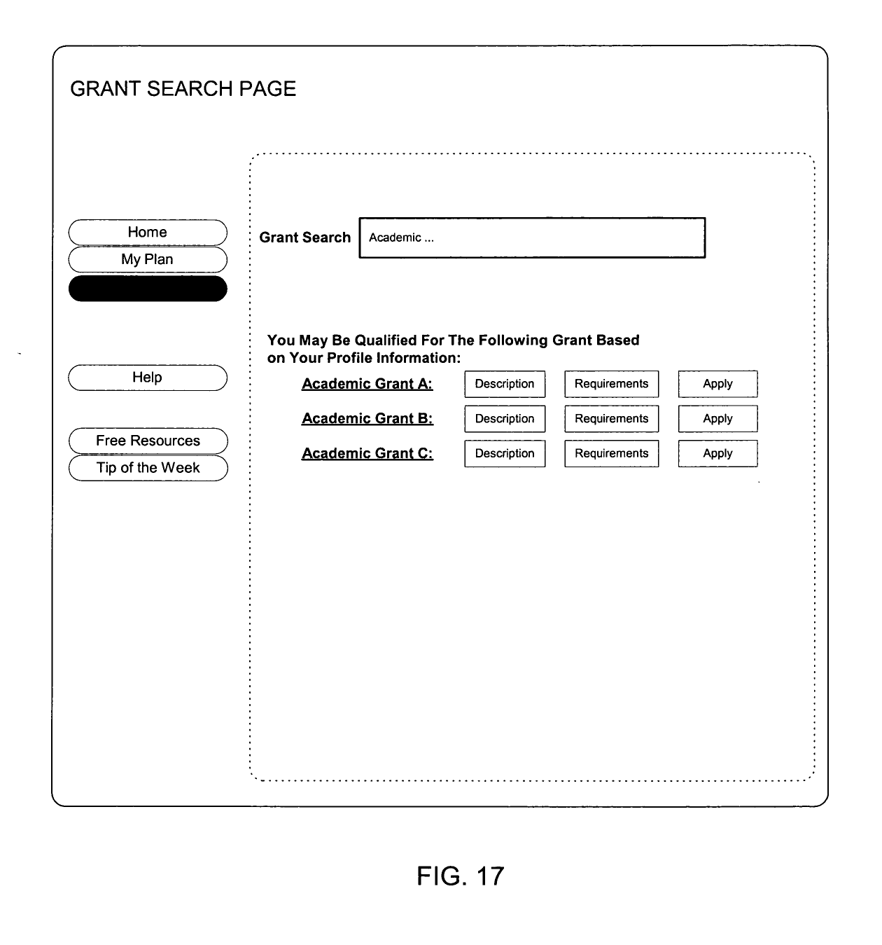

Another feature of the present invention includes an on-line grant module that allows the user to search and apply for grants from his or her user. A “Grant Search Link” allows the user to access an exemplary Grant Search page shown in FIG. 17. As shown, this page allows the user to search for grants. The search result presented to the user allows him or her to get a description of the grant as well as information regarding requirements for applying for the discovered grant. Corresponding “Apply” links allow the user to apply for a desired grant on line.

The User Home page shown in FIG. 16 also provides links to news and events directed to certification requirements, for example, news regarding state certification in a professional field. This page, which can be personalized, gives the user information concerning their profession and certification needs. In addition, the user can obtain degree program materials that are related to certification process so that they can fulfill requirements necessary for their personalized certification plan. Additionally, supplementary reading material suggestions may be provided on this page.

Also the page may provide links to discussion forums with a certification authority representative or any private or public institution and agency that tracks certification requirements. This page can also provide links for obtaining certification forms and contact information, for example, the appropriate certification authority department, board or committee.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A system accessible by a user for planning and tracking certification, comprising:
planner that generates one or more certification goals based on a user profile and an authority profile associated with a certification authority, wherein the planner is responsive to user selection of one or more of the generated certification goals for creating a certification plan; and
a tracker that updates the certification plan in response to input regarding achievement of the one or more selected certification goals.

2. The system of claim 1, wherein the certification plan relates to at least on of certification, re-certification, licensing, re-licensing in a field of endeavor.

3. The system of claim 2, wherein the field of endeavor comprises a field relating to ate least one of education, teaching, medical, engineering, legal, accounting, and sports.

4. The system of claim 1, wherein the certification authority comprises at least one of a federal government, state government, county government, local government, municipal government, public official, private official, governmental agency, non-governmental agency, public institution, and private institution.

5. The system of claim 1, wherein the planner is responsive to at least one of Needs Assessment and Certification Credit information for generating the certification.

6. The system of claim 1, wherein the planner is responsive to certification credit transfer from another certification authority for generating the certification goals

7. The system of claim 1, wherein the tracker updates the certification plan based on at least one of a user input and non-user input.

8. The system of claim 1, wherein the planner prioritizes the generated certification goals based on one or more certification requirements of the certification authority.

9. The system of claim 1 further including a certification resource generator that associates at least one of the certification goals with at least one certification resource.

10. The system of claim 1, wherein the certification resource comprise at least one of a course, program, session, seminar, audio lecture, video lecture, a book, a test, and a form.

11. The system of claim 1, wherein has a format comprising at least one of a course, session, seminar, degree program, test, form, book, audio, and video.

12. The system of claim 1, wherein the course comprises at least one of a live course and a self-paced course.

13. The system of claim 1 further including an on-line system accessible by the user for at least one receiving, ordering, and registering for a certification resource.

14. The system of claim 1, wherein the planner transmits the certification plan to the certification authority for approval.

15. The system of claim 1, wherein the tracker transmits an e-mail to the user in connection with a certification goal.

16. The system of claim 1, wherein the tracker alerts the user regarding a certification goal deadline.

17. The system of claim 1 further including an on-line grant module accessible by the user to search for a grant.

18. The system of claim 1, wherein the on-line grant module allows the user to apply for a selected grant.
